(19) United States
(12) Patent Application Publication
(10) Pub. No.: US 2014/0306169 A1
(43) Pub. Date: Oct. 16, 2014

(54) THIN JACK DEVICE FOR BRIDGE LIFTING

(71) Applicant: China Engineering Consultants, Inc., Taipei City (TW)

(72) Inventors: Ching-Lung Liao, Taipei City (TW); Min Chao, Kaohsiung City (TW); Chung-Yue Wang, New Taipei City (TW); Jin-Chung Ma, New Taipei City (TW)

(73) Assignee: China Engineering Consultants, Inc., Taipei City (TW)

(21) Appl. No.: 14/251,842

(22) Filed: Apr. 14, 2014

(30) Foreign Application Priority Data
Apr. 15, 2013 (TW) 102113372

(51) Int. Cl. B66F 3/25

(52) U.S. Cl. CPC B66F 3/25
USPC 254/93 R

(57) ABSTRACT

A thin jack device for bridge lifting is disclosed, comprising a base seat; a lifting unit, movably connected with the base seat; and a displacement sensor, disposed at a side of the base seat. In this manner, an arrangement may be applied when a gap altitude between a bridge girder and a pier is insufficient to reduce a risk possibility of violation of the bridge and pier, and a displacement sensors attached to stroke is used to monitor a raised altitude to reduce a mechanical error to promote safety and thereby sufficiently the current pier structure to save a temporarily used pier or a frame based design and construction, whereby increasing the construction safety and decreasing the construction cost.

### FIELD OF THE INVENTION

The present invention relates to a thin jack device for bridge lifting, and particularly to a thin jack device for bridge lifting, where an arrangement may be applied when a gap altitude between a bridge girder and a pier is insufficient to reduce a risk possibility of violation of the bridge and pier, and a displacement sensors attached to stroke is used to monitor a raised altitude to reduce a mechanical error to promote safety and thereby sufficiently the current pier structure to save a temporarily used pier or a frame based design and construction, whereby increasing the construction safety and decreasing the construction cost.

### DESCRIPTION OF THE RELATED ART

At present, the bridge lifting construction method is generally implemented by screwing a supporting bracket at an outer side of an abutment or pier cap structure body, whereby an operational platform for setting up a jack.

However, the safety of this construction depends upon the strength of the bolt and concrete at the screwing position, which are largely affected by a material type, a mating ratio and the environmental factors. Furthermore, in the case that the construction bracket adopts a point supporting form, the weight of the upper structure of the bridge may concentrate at a side owing to an inclination shift resulting from a position variance in the lifting course. This may lead to an increased force on the construction bracket, bringing about a failure of the jack support. This might further cause a chained effect, resulting in damage of the bridge structure.

In view of the drawbacks mentioned above, the inventor of the present invention provides a thin jack device for bridge lifting, after many efforts and researches to overcome the shortcoming encountered in the prior art.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a schematic diagram for a cross sectional state according to a first embodiment of the present invention;

FIG. 2 is a schematic diagram for a use state according to the first embodiment of the present invention; and

FIG. 3 is a schematic diagram for a cross sectional state according to a second embodiment of the present invention.

### DESCRIPTION OF THE PREFERRED EMBODIMENTS

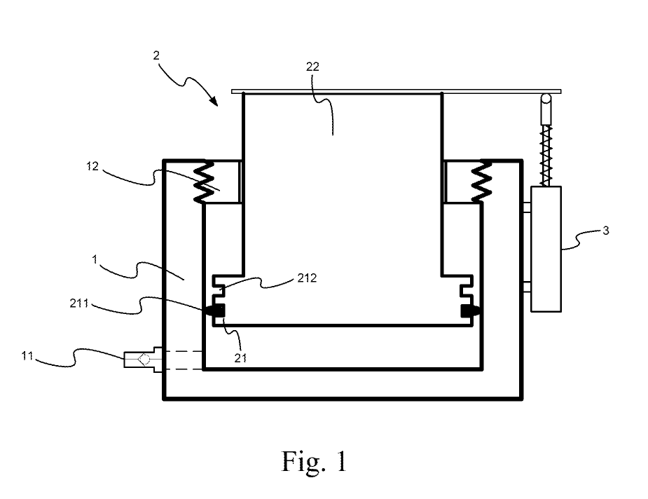

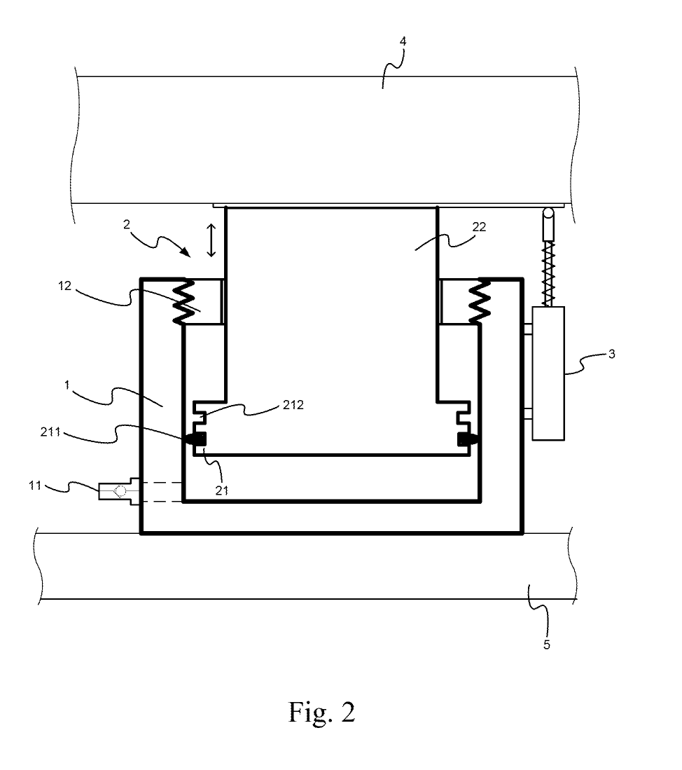

Referring to FIG. 1 and FIG. 2, a schematic diagram for a cross sectional state and a use state according to a first embodiment of the present invention are shown, respectively. As shown, a thin jack device for bridge lifting of the present invention comprises a base seat 1, a lifting unit 2 and a displacement sensor 3.

The base seat 1 is an oil cylinder, and the base seat 1 is communicatively connected to a Check Valve 11 at it one side.

Further, the base seat 1 has a ring at it one end at a rushing stop unit 12, which is disposed at an outer rim of the lifting unit 2.

The lifting unit 2 is movably connected with the base sear 1. And, the lifting unit 2 comprises a position limiting portion 21, which is located within the base seat 1, and a cylinder body 22, which is disposed at an end face of the position limiting portion 21 and extending out of the base seat 1.

An oil seal 211 and a wear resistant ring 212 are disposed on a circumference of the position limiting portion 21, respectively.

The displacement sensor 3 is disposed at a side of the base seat 1.

When the present invention is operated, a non-violating apparatus, such as a ground penetrating radar or other non-violating detection apparatus; not shown) is used to measure a thickness of a protection layer of the pier 5, so as to detect a position where the steel is arranged. Furthermore, the protection layer of the concrete is sliced at its surface layer by slicing or digging by using a mechanical tooling, thereby increasing a space for receiving the think jack therein.

Then, the thin jack is placed on a bearing place for operation between the bridge 4 and the pier 5, so that the base seat 1 is disposed at the pier 5 and the lifting unit 2 is disposed right below the bridge 4, and the displacement sensor 3 is located between the pier 5 and the bridge 4.

After the above arrangement is completed, a high pressure oil tube (now shown) of the Check Valve 11 is open, so that a hydraulic oil flows into the base seat 1 to push the cylinder body 22 of the lifting unit 2 to raise upwards the bridge 4.

In the lifting course, except that the rushing stop unit 12 and the position limiting portion 21 are used to avoid the cylinder body 2 to have an over-rushing course, an oil seal 211 and a wear resistant ring 212 may further be used to fill gaps between the cylinder 22 and the base seat 1 to avoid a leakage of the hydraulic oil and increase a stability of the cylinder body 22 lifting, i.e. avoid an abrupt rushing for safety reason. And, when the lifting unit 2 is operated, a displacement sensor 3 is employed to measure the position to which the cylinder body 22 moves, and output a placement conversion analog signal, so as to monitor on line a lifting altitude of the lifting unit 2 by using the displacement sensor 3 together with a signal acquisition system (now shown). The lifting altitude of the lifting unit 2 is maintained at a maximum rushing course limit of 25 mm, so as to assure the construction safety.

As such, in the case that only some small spaces exist or no any seam appearing at the bearing portion of the upper and lower structures of the bridge 4, it may be possible to raise the bridge 4 by detecting the protection layer thickness in a non-violating fashion, and thus this technology may be applied onto the case where a high flood prevention standard is required to promote a water area and some construction like that. Not only the concrete waste torn down from the bridge 4 satisfies with the ecological protection purpose, but also the current pier structure may be directly supported. As such, the temporal supporting equipment or the construction with additionally used frames may be saved, whereby advantages of short construction time, increased construction safety and reduced cost for a construction task may be achieved.

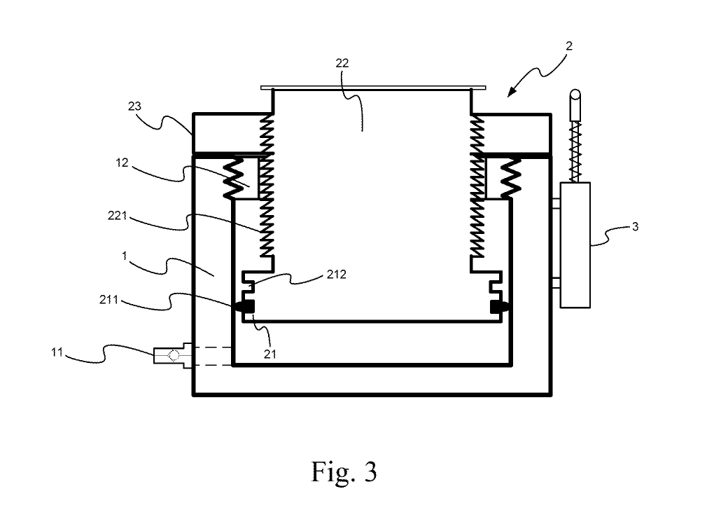

Referring to FIG. 3, in which a schematic diagram for a cross sectional state according to a second embodiment of the present invention. As shown, the present invention may also be implemented in the structure from as defined as the second embodiment of the present invention.

The difference of the second embodiment, compared with the first embodiment, dwells in that the cylinder body 22 has a threading portion 221, and the threading portion 221 is a sling square thread guiding a unidirectional movement. Further, the cylinder body 22 has a follower safety unit 23 mating the threading portion 221 sleeved thereon.

When the lifting unit 2 is involved in its lifting operation on the base seat 1, except that the rushing stop unit 12, the position limiting portion 21, the oil seal 211 and the wear resistant ring 212 are used to avoid the over-rushing course of the cylinder body 22 and increase the stability of the cylinder body 22, the mating between the threading portion 221 and the follower safety unit 23 may also be employed to enable the cylinder body 22 to rotate the follower safety unit 23 in the lifting course of the cylinder body 22, so as to maintain a tight contact between the follower safety unit 23 and the base seat 1. As such, the cylinder body 22 may be exempted from an abrupt leakage drop, and thus the jack lifting may be promoted with its safety.

In view of the above, the thin jack device for bridge lifting of the present invention may overcome the drawbacks in the prior art, and instead an arrangement may be applied when a gap altitude between a bridge girder and a pier is insufficient to reduce a risk possibility of violation of the bridge and pier, and a displacement sensors attached to stroke is used to monitor a raised altitude to reduce a mechanical error to promote safety and thereby sufficiently the current pier structure to save a temporarily used pier or a frame based design and construction, whereby increasing the construction safety and decreasing the construction cost. Therefore, the present invention can be deemed as more practical, improved and necessary to users, compared with the prior art.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the appended claims.

What is claimed is:

1. A thin jack device for lifting a bridge, comprising:
a base seat;
a lifting unit, movably connected with the base seat; and
a displacement sensor, disposed at a side of the base seat.

2. The thin jack device for lifting the bridge as claimed in claim 1, wherein the base seat is an oil cylinder, and the base seat is communicatively connected to a Check Valve at a side thereof.

3. The thin jack device for lifting the bridge as claimed in claim 1, wherein the base seat has a ring at an end thereof at a rushing stop unit disposed at an outer rim of the lifting unit.

4. The thin jack device for lifting the bridge as claimed in claim 1, wherein the lifting unit comprises a position limiting portion within the base seat and a cylinder body disposed at an end face of the position limiting portion and extending out of the base seat.

5. The thin jack device for lifting the bridge as claimed in claim 4, wherein the lifting unit further has an oil seal and a wear resistant ring disposed on a circumference of the position limiting portion.

6. The thin jack device for lifting the bridge as claimed in claim 4, wherein the lifting unit has a thread portion disposed on the cylinder body, and the cylinder body has a follower safety unit mating with the screw portion sleeved thereon.

7. The thin jack device for lifting the bridge as claimed in claim 6, wherein the thread portion is a sling square thread for guiding a unidirectional movement.
